(19) United States
(12) Patent Application Publication
(10) Pub. No.: US 2025/0238223 A1
(43) Pub. Date: Jul. 24, 2025

(54) VEHICLE SOFTWARE MANAGEMENT APPARATUS AND VEHICLE SOFTWARE MANAGEMENT SYSTEM

(71) Applicant: Mitsubishi Electric Corporation, Tokyo (JP)

(72) Inventors: Takuya KONO, Tokyo (JP); Akihiro SANADA, Tokyo (JP); Nozomi YAMADA, Tokyo (JP)

(73) Assignee: Mitsubishi Electric Corporation, Tokyo (JP)

(21) Appl. No.: 18/854,081

(22) PCT Filed: Apr. 12, 2022
(86) PCT No.: PCT/JP2022/017549

§ 371 Date: Oct. 4, 2024

(51) Int. Cl. G06F 8/65

(52) U.S. Cl. CPC G06F 8/65

(57) ABSTRACT

There is obtained a vehicle software management apparatus that makes it possible that even when a control apparatus is abnormal, updation to a version of software with which provision of a stopped service can be continued. The vehicle software management apparatus includes
an information acquisition unit that acquires control-apparatus state information, software function-version information, and software-service information,
a stopped-service detection unit that detects a stopped service that has been made inexecutable by the control apparatus whose operation is abnormal,
a communication unit that transfers the control-apparatus state information and the stopped-service information to an outside-vehicle server, and
a software updating unit. The communication unit receives, from the outside-vehicle server, a version of software with which the stopped service is executed by a normal control apparatus; the software updating unit instructs the control apparatus on updation to the received software.

### TECHNICAL FIELD

The present disclosure relates to a vehicle software management apparatus and a vehicle software management system.

### BACKGROUND ART

In recent years, in the automobile industry, adoption of software updating for a vehicle control apparatus, utilizing an OTA (Over The Air) technology, has been started. An OTA technology denotes transmitting and receiving data by use of wireless communication. In particular, in many cases, data communication for, in a wireless-communication terminal typified by a smartphone, updating an OS (Operating System) for the wireless-communication terminal itself or updating set application software is referred to as OTA.

A technology for stably updating software for a vehicle control apparatus by use of an OTA technology has been proposed. There has been disclosed a technology in which in the case where rewriting of software is executed, it is determined whether or not the software can be rewritten, in accordance with an environment under which each of vehicle control apparatuses is located (for example, Patent Document 1).

### CITATION LIST

### Patent Literature

Patent Document 1: Japanese Patent Application Laid-Open No. 2006-268554

### SUMMARY OF INVENTION

### Technical Problem

In the technology disclosed in Patent Document 1, when software for a vehicle control apparatus is updated, the environment under which the vehicle control apparatus is located is considered. For example, whether or not software can be rewritten is determined, in consideration of the temperature and the voltage of a vehicle control apparatus, the elapsed time after an engine has been turned off, and the like. As a result, software updating utilizing an OTA technology can be executed in a stable environment.

However, in the technology disclosed in Patent Document 1, management of software at a time when two or more software items collaborate with one another so as to realize provision of a service is not considered. In addition, it is not assured that respective software items are combined with one another so as to be able to normally operate. Moreover, there has not been considered the maintenance of service provision at a time when a control apparatus becomes abnormal. In the case where the operation of a control apparatus mounted in a vehicle indicates an abnormality, it becomes difficult to provide services related to software items to be executed by the control apparatus whose operation has indicated the abnormality.

The present disclosure has been implemented in order to solve the foregoing problems. The objective thereof is to obtain a vehicle software management apparatus and a vehicle software management system that make it possible that even when the operation of a control apparatus indicates an abnormality, there is performed software updating to a software version capable of continuing service provision that has been stopped.

### Solution to Problem

A vehicle software management apparatus according to the present disclosure includes
an information acquisition unit that acquires control-apparatus state information that indicates whether two or more control apparatuses provided in a vehicle operate normally or abnormally, function-version information that indicates a function and a version of software to be executed by each of the control apparatuses, and software-service information that indicates a relationship between the software and a service to be executed by use of the software,
a stopped-service detection unit that detects a stopped service that is the service that has been made inexecutable by the control apparatus whose operation is abnormal,
a communication unit that transfers, to an outside-vehicle server, the control-apparatus state information acquired by the information acquisition unit and stopped-service information from the stopped-service detection unit, and
a software updating unit that instructs the control apparatus to update the software.

In the case where the stopped-service detection unit detects the stopped service, the communication unit receives, from the outside-vehicle server, a version of the software with which a normal control apparatus executes the stopped service; the software updating unit instructs the control apparatus on updation to the software received from the outside-vehicle server.

A vehicle software management system according to the present disclosure includes
an outside-vehicle server including
   a storage unit that stores respective functions and versions of a plurality of software items to be executed by each of control apparatuses provided in a vehicle and software-service information indicating a relationship between software and a service to be executed by use of the software,
   an outside-vehicle-server communication unit that transmits the software in response to a request from the vehicle software management apparatus and receives the control-apparatus state information and the stopped-service information from the vehicle software management apparatus,
   a software retrieval unit that retrieves, from the software-service information in the storage unit, a version of the software with which the normal control apparatus executes a stopped service, in the case where the stopped-service information received by the outside-vehicle-server communication unit indicates existence of the stopped service, and
   a countermeasure-software transfer unit that reads, from the storage unit, the software whose version has been retrieved by the software retrieval unit and that makes the outside-vehicle-server communication unit transmit the software to the vehicle software management apparatus, and
a vehicle software management apparatus.

### Advantageous Effects of Invention

In a vehicle software management apparatus and a vehicle software management system according to the present disclosure, the vehicle software management apparatus receives, from an outside-vehicle server, a software version with which a stopped service is executed by a normal control apparatus. Accordingly, it is made possible to update the version of the software to the version with which even when the operation of the control apparatus indicates an abnormality, provision of the service can be continued. As a result, provision of necessary services can be continued; thus, the convenience is enhanced.

### BRIEF DESCRIPTION OF DRAWINGS

FIG. 1 is a configuration diagram of a vehicle software management apparatus according to Embodiment 1;

FIG. 2 is a hardware configuration diagram of the vehicle software management apparatus according to Embodiment 1;

FIG. 3 is a table representing function-version information on software items according to Embodiment 1;

FIG. 4 is a first table representing software-service information according to Embodiment 1;

FIG. 5 is a second table representing software-service information according to Embodiment 1;

FIG. 6 is a third table representing software-service information according to Embodiment 1;

FIG. 7 is a table representing control-apparatus state information according to Embodiment 1;

FIG. 8 is a table representing stopped-service information according to Embodiment 1;

FIG. 9 is a flowchart of software-updating processing by the vehicle software management apparatus according to Embodiment 1;

FIG. 10 is a flowchart of stopped-service corresponding processing by the vehicle software management apparatus according to Embodiment 1;

FIG. 11 is a configuration diagram of a vehicle software management system according to Embodiment 2;

FIG. 12 is a first flowchart of communication processing by an outside-vehicle server according to Embodiment 2;

FIG. 13 is a second flowchart of the communication processing by the outside-vehicle server according to Embodiment 2;

FIG. 14 is a second flowchart of communication processing by the outside-vehicle server according to Embodiment 3; and

FIG. 15 is a table representing software-service information according to Embodiment 3.

### DESCRIPTION OF EMBODIMENTS

Hereinafter, respective vehicle software management apparatuses according to Embodiments of the present disclosure will be explained with reference to the drawings.

### 1. Embodiment 1

### <Configuration of Vehicle Software Management Apparatus>

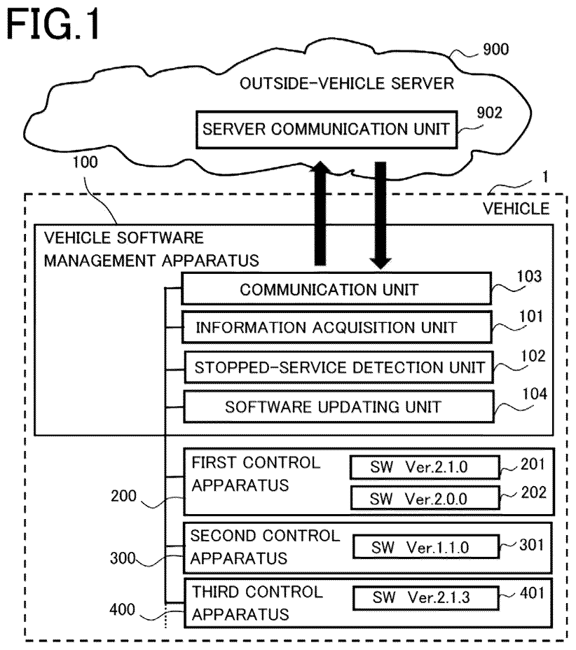

FIG. 1 is a configuration diagram of a vehicle software management apparatus 100 according to Embodiment 1. The vehicle software management apparatus 100 is mounted in a vehicle 1 and has a communication unit 103, an information acquisition unit 101, a stopped-service detection unit 102, and a software updating unit 104.

The vehicle software management apparatus 100 and an outside-vehicle server 900 can communicate with each other through a wide area communication network such as a mobile network. Specifically, the vehicle software management apparatus 100 and the outside-vehicle server 900 communicate with each other through the communication unit 103 and a server communication unit 902. The outside-vehicle server 900 can transmit updating software for raising vehicle function to the vehicle software management apparatus 100. FIG. 1 represents the case where the outside-vehicle server 900 is configured on a cloud; the configuration is represented by a drawing in which the outside-vehicle server 900 is on a cloud. In some cases, the outside-vehicle server 900 is referred to as an OTA server.

The vehicle software management apparatus 100 mounted in the vehicle 1 is connected with a first control apparatus 200, a second control apparatus 300 and a third control apparatus 400. The first control apparatus 200 has the version 2.1.0 of software 201 and the version 2.0.0 of software 202 and executes these software items (“SW” denotes software, and “Ver.” denotes a version). The second control apparatus 300 has the version 1.1.0 of software 301 and executes this software. The third control apparatus 400 has the version 2.1.3 of software 401 and executes this software. FIG. 1 represents the case where the first control apparatus 200, the second control apparatus 300, and the third control apparatus 400, i.e., three pieces of control apparatuses, are connected with the vehicle software management apparatus 100; however, the number of the control apparatuses is not limited thereto.

Through the communication unit 103, the vehicle software management apparatus 100 issues a request for the latest version of updating software to the outside-vehicle server 900. The vehicle software management apparatus 100 that has received the updating software from the outside-vehicle server 900 through the communication unit 103 transfers the updating software to the control apparatus that should execute it; then, the software updating unit 104 issues a rewriting instruction to the corresponding control apparatus.

The information acquisition unit 101 of the vehicle software management apparatus 100 acquires control-apparatus state information, function-version information, and software-service information. The control-apparatus state information is the one that indicates whether the operation of each of the control apparatuses is normal or abnormal. The function-version information is the one that indicates the function and the version of software to be executed by each of the control apparatuses. The software-service information is the one that indicates the relationship between software and a service to be performed by use of the software.

### <Hardware Configuration of Vehicle Software Management Apparatus>

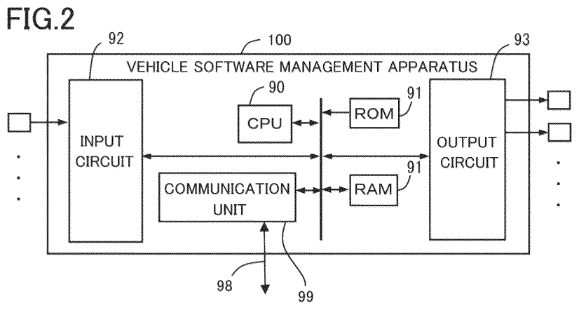

FIG. 2 is a hardware configuration diagram of the vehicle software management apparatus 100 according to Embodiment 1. The configuration diagram in FIG. 2 can be applied also to the first control apparatus 200, the second control apparatus 300, the third control apparatus 400, and the outside-vehicle server 900. Hereinafter, as the representative, the vehicle software management apparatus 100 will be explained. Respective functions of the vehicle software management apparatus 100 are realized by processing circuits provided in the vehicle software management apparatus 100. Specifically, as illustrated in FIG. 2, the vehicle software management apparatus 100 includes, as processing circuits, a computing processing unit (computer) 90 such as a CPU (Central Processing Unit), the storage apparatuses 91 that exchange data with the computing processing unit 90, an input circuit 92 that inputs external signals to the computing processing unit 90, an output circuit 93 that outputs signals from the computing processing unit 90 to the outside, and an interface, such as the communication unit 99, that transmits or receives data via a communication path 98.

It may be allowed that as the computing processing unit 90, an ASIC (Application Specific Integrated Circuit), an IC (Integrated Circuit), a DSP (Digital Signal Processor), an FPGA (Field Programmable Gate Array), any one of various kinds of logic circuits, any one of various kinds of signal processing circuits, or the like is provided. The SoC (System on a Chip) technology may be applied to the computing processing unit 90. In addition, it may be allowed that as the computing processing unit 90, two or more computing processing units of the same type or different types are provided and respective processing items are executed in a sharing manner. In the vehicle software management apparatus 100, as the storage apparatuses 91, there are provided a RAM (Random Access Memory) that can read data from and write data in the computing processing unit 90, a ROM (Read Only Memory) that can read data from the computing processing unit 90, and the like. The storage apparatuses 91 may be incorporated in the computing processing unit 90. The input circuit 92 is connected with an input signal, a sensor, and a switch and is provided with an A/D converter and the like for inputting the input signal and signals from the sensor and the switch to the computing processing unit 90. The output circuit 93 is connected with electric loads such as a gate driving circuit for on/off-driving switching devices and the like, and is provided with a driving circuit and the like for outputting control signals from the computing processing unit 90 to these electric loads. Via the communication path 98, the communication unit 99 can exchange data with an external apparatus such as an external control apparatus.

The computing processing unit 90 runs software items (programs) stored in the storage apparatus 91 such as a ROM and collaborates with other hardware devices in the vehicle software management apparatus 100, such as the storage apparatus 91, the input circuit 92, and the output circuit 93, so that the respective functions provided in the vehicle software management apparatus 100 are realized. In addition, setting data items such as a threshold value and a determination value to be utilized in the vehicle software management apparatus 100 are stored, as part of software items (programs), in the storage apparatus 91 such as a ROM. It may be allowed that the respective functions included in the vehicle software management apparatus 100 are configured with either software modules or combinations of software and hardware.

### <Function-Version Information>

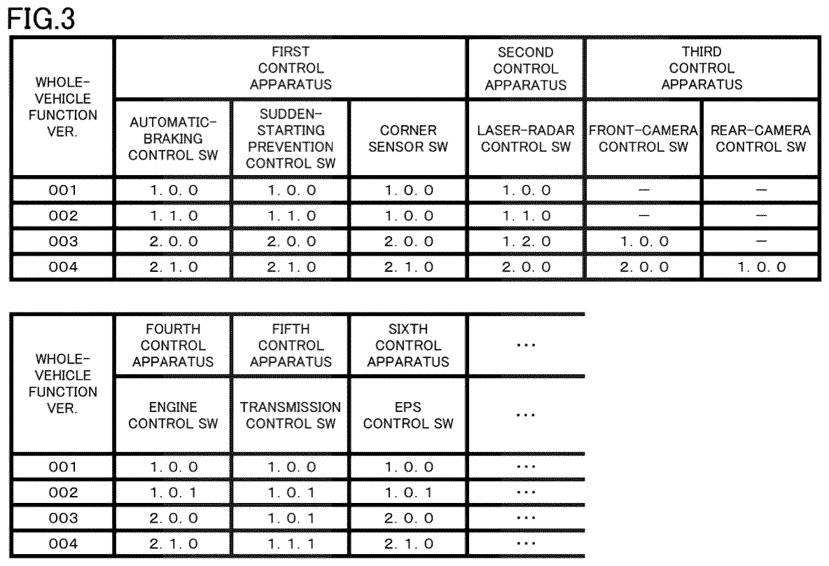

FIG. 3 is a table representing software function-version information items for the whole of the vehicle 1 according to Embodiment 1. The names of the control apparatuses are described in the first row of FIG. 3; the names or software items to be installed in the respective control apparatuses are described in the second row thereof. Below the second row, the versions of software items corresponding to the respective function versions are described. In the case where two or more software items operate in a collaboration manner, collaborative operation is assured when the respective software versions have one and the same function version.

In FIG. 3, automatic-braking control software, sudden-starting prevention control software, and corner sensor software are installed in the first control apparatus. Then, in the case where the function version is “001”, the versions of the automatic-braking control software, the sudden-starting prevention control software, and the corner sensor software are “1.0.0”, “1.0.0”, “1.0.0”, respectively.

Laser-radar control software is installed in the second control apparatus. In the case where the function version is “001”, the version of the laser-radar control software is “1.0.0”.

Front-camera control software and rear-camera control software are installed in the third control apparatus. In the case where the function version is any one of “001” and “002”, neither the front-camera control software nor the rear-camera control software can be utilized.

The front-camera control software can be utilized in the case where function version is after and including “003”. In the case where the function version is “003”, the version of the front-camera control software is “1.0.0”. The rear-camera control software can be utilized in the case where function version is after and including “004”. In the case where the function version is “004”, the version of the rear-camera control software is “1.0.0”.

Also with regard to a fourth control apparatus, a fifth control apparatus, and a sixth control apparatus, software items to be installed therein are described. In the present embodiment, the explanations for these software items will be omitted. In addition, the number of the control apparatuses is not limited to 6.

### <Software Updating and Rollback>

In the software function-version information in FIG. 3, an example in which the function version is upgraded from “001” to “004” is represented. For example, there will be considered the case where when the function version is “003”, the version of software held by the outside-vehicle server 900 is upgraded to the function version “004”.

The vehicle software management apparatus 100 mounted in the vehicle 1 learns that the function version of the currently held software is “003” and that the software held by the outside-vehicle server 900 has been updated and hence the latest software whose function version is “004” can be provided. in this situation, the vehicle software management apparatus 100 issues, to the outside-vehicle server 900, a request for transmitting the latest version of the software. Then, after receiving the latest version of the software from the outside-vehicle server 900 and then instructs the respective control apparatuses to update software items.

In the case where when software updating is executed, there exists a control apparatus, among the updation-subject control apparatuses, that cannot correctly execute the software updating, processing in which the states of the software items in all the control apparatuses are restored to the states thereof before the updation is performed. This processing is referred to as a rollback. A rollback makes it possible that a problem is prevented from being caused by software updating and hence stably operation of a vehicle is maintained.

The rollback is performed not only at a time of software updating but also at a time of another occurrence. Also in the case where while ordinary software is executed, it is found that an abnormality exists in the control apparatus, the abnormality is dealt with by restoring the function version to its immediately previous one.

### <Software-Service Information>

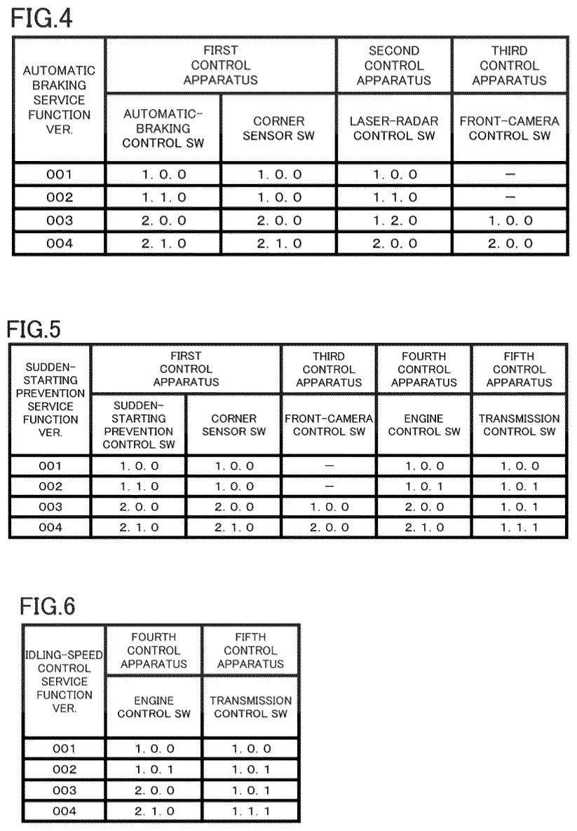

FIG. 4 is a first table representing software-service information according to Embodiment 1. The service denotes functional convenience that can be provided to a driver of the vehicle 1. The service denotes the functions that raise the performance, the comfortability, the stability, the reliability, the failure resistance, and the like of a vehicle. The service is realized by a single or two or more software items. Among the services provided by a vehicle, there exist large-scale services, such as an ADAS (Advanced Driving Assistant System) function and an automatic-driving function, that require collaboration of two or more control apparatuses and two or more software items. The software-service information is information related to the relationship between a service and software that realizes the service.

In FIG. 4, as a service, an automatic braking service is described. The automatic braking service is a service that prevents a crash by detecting an object or a human around the vehicle 1 and then automatically applying the brakes.

Each of the function versions “001” and “002” of the automatic braking service is a service to be realized by collaboration of the automatic-braking control software and the corner sensor software installed in the first control apparatus and the laser-radar control software installed in the second control apparatus. It is represented that in the function version after and including “003” of the automatic braking service, the front-camera control software installed in the third control apparatus also participates in the collaboration.

FIG. 5 is a second table representing the software-service information according to Embodiment 1. In FIG. 5, as a service, a sudden-starting prevention service is described. The sudden-starting prevention service is a service that suppresses sudden acceleration when the vehicle 1 is suddenly accelerated from its stoppage state or slow-speed state, by consulting the surrounding situation and then controlling the transmission and the engine, in consideration of erroneous stepping on the brake pedal or the accelerator pedal.

Each of the function versions “001” and “002” of the sudden-starting prevention service is a service to be realized by collaboration of the sudden-starting prevention control software and the corner sensor software installed in the first control apparatus, engine control software installed in the fourth control apparatus, and transmission control software installed in the fifth control apparatus. It is represented that in the function version after and including “003” of the sudden-starting prevention service, the front-camera control software installed in the third control apparatus also participates in the collaboration.

FIG. 6 is a third table representing the software-service information according to Embodiment 1. In FIG. 5, as a service, an idling-speed control service is described. The idling-speed control service is a service that optimizes the balance among the heater load, the air-conditioner load, the gasoline mileage, the inner-vehicle noise, the vibration, and the like, by adjusting the rotation speed of the engine in the idling state. The idling-speed control service is a service to be realized by collaboration of the engine control software installed in the fourth control apparatus and the transmission control software installed in the fifth control apparatus.

### <Abnormality in Control Apparatus and Stoppage of Service>

There will be considered the case where in the vehicle 1, an abnormality in the operation of the third control apparatus is detected while the whole-vehicle function version “004” of software is executed. In this case, an abnormality in the third control apparatus is detected. Then, due to the abnormality in the third control apparatus, the automatic braking service represented in FIG. 4 and the sudden-starting prevention service represented in FIG. 5 cannot be executed and then are detected, as stopped services.

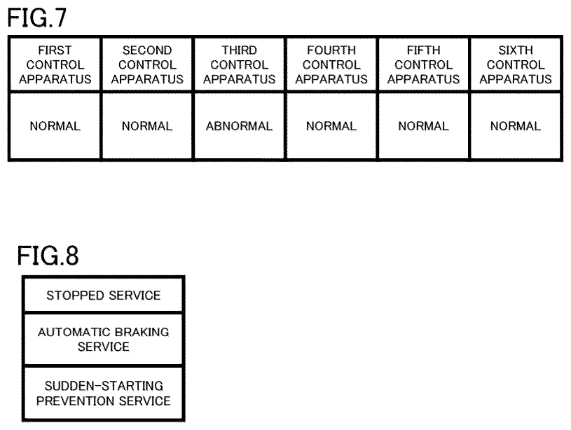

FIG. 7 is a table representing control-apparatus state information according to Embodiment 1. FIG. 8 is a table representing stopped-service information according to Embodiment 1. As represented in FIG. 7, an abnormality in the third control apparatus is indicated in the control-apparatus state information. Then, as represented in FIG. 8, the automatic braking service and the sudden-starting prevention service are indicated in the stopped-service information.

In the case where in this situation, rollback processing is performed, the function version returns to “003”. The vehicle software management apparatus 100 requests the outside-vehicle server 900 to transmit the function version “003” of the software and receives it; then, the vehicle software management apparatus 100 instructs the corresponding control apparatus to update the software. However, even when the software for the corresponding control apparatus is rewritten back to the function version “003”, the automatic braking service described in FIG. 4 and the sudden-starting prevention service described in FIG. 5 cannot be executed; thus, these services remain in the stoppage state.

In this case, the rollback processing for the immediately previous version cannot be a solution. Accordingly, the driver continues the driving, while giving up receiving provision of these services, or he cannot utilize the vehicle until repair thereof at a repair shop has been completed.

<Software Version that does not Utilize Abnormal Control Apparatus>

There is searched a software version with which even when an abnormality occurs in the third control apparatus, the services can be continued without utilizing the third control apparatus. In FIG. 4, when the function version is “002”, the automatic braking service can be continued without the third control apparatus. In FIG. 5, when the function version is “002”, the sudden-starting prevention service can be continued without the third control apparatus.

Accordingly, in order to update the function version of each of all the control apparatuses to “002”, the vehicle software management apparatus 100 receives the function version “002” of the software from the outside-vehicle server 900. Then, the corresponding control apparatuses are made to write the function version “002” of the software.

From the outside-vehicle server 900, the vehicle software management apparatus 100 receives the software version with which the stopped services are executed by normal control apparatuses. Accordingly, it is made possible to update the version of the software to the version with which even when the operation of the control apparatus indicates an abnormality, provision of the service can be continued. As a result, provision of necessary services can be continued; thus, the convenience is enhanced.

### <Software-Updating Processing>

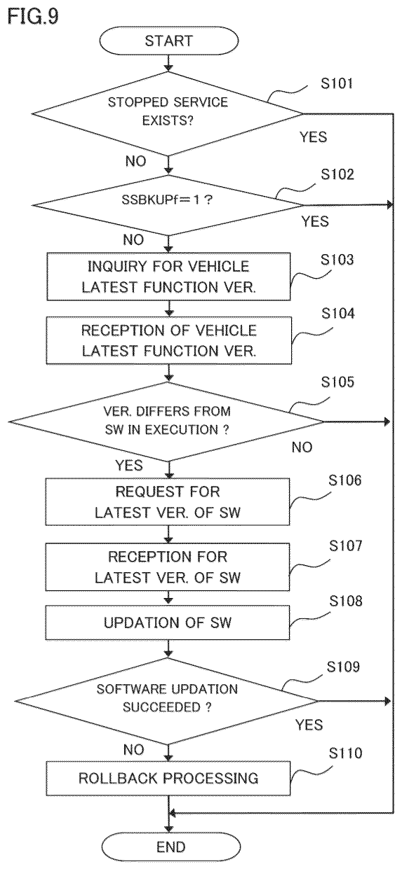

FIG. 9 is a flowchart of software-updating processing by the vehicle software management apparatus 100 according to Embodiment 1. Processing contents to be utilized in software-updating processing are written in the storage apparatus 91 of the vehicle software management apparatus 100. The computing processing unit 90 of the vehicle software management apparatus 100 executes the processing contents.

The processing in the flowchart in FIG. 9 is performed every predetermined time (for example, every 10 ms). The processing represented in FIG. 9 may be performed not every predetermined time but every event, for example, each time the vehicle has traveled a predetermined distance or each time the vehicle software management apparatus 100 has received data from the outside-vehicle server 900.

After the processing is started, it is determined in the step S101 whether or not there exists a stopped service detected by the stopped-service detection unit 102. In the case where there exists a stopped service (the determination result is “YES”), the processing is ended. In the case where there exists no stopped service (the determination result is “NO”), the step S101 is followed by the step S102.

In the step S102, it is determined whether or not a stopped-service backup flag SSBKUPf has been set. The stopped-service backup flag SSBKUPf is a flag indicating that a stopped service has been detected and then processing for dealing therewith is being performed. In the case where the stopped-service backup flag SSBKUPf has been set, updation of software items for the respective control apparatuses to the latest versions are not executed.

In the case where the stopped-service backup flag SSBKUPf has been set (the determination result is “YES”), the processing is ended. In the case where the stopped-service backup flag SSBKUPf has not been set (the determination result is “NO”), the step S102 is followed by the step S103.

In the step S103, through the communication unit 103, the outside-vehicle server 900 is inquired about the latest function version of the software for the vehicle 1 that can be provided by the outside-vehicle server 900. In the step S104, the communication unit 103 receives the latest version of the software from the outside-vehicle server 900.

In the step S105, it is determined whether or not the function version of the software that is being executed by the vehicle 1 is different from the latest version received from the outside-vehicle server 900. In the case where the version is the same as the latest version (the determination result is “NO”), the processing is ended. In the case where the version is different from the latest version (the determination is “YES”), the step S105 is followed by the step S106.

In the step S106, the communication unit 103 requests the outside-vehicle server 900 to transmit the latest version of the software. In this case, there exists a case where even when the function version is changed, the version of each of the software items is not changed. In that case, because not required, transmission/reception and updating processing of the software may be omitted, depending on the software. In the step S107, the communication unit 103 receives the latest version of the software from the outside-vehicle server 900.

In the step S108, the software updating unit 104 of the vehicle software management apparatus 100 instructs the corresponding control apparatus to update the software. In the step S109, it is determined whether or not the software updating has succeeded. In the case where all the software items have been completed without any problem, the processing is ended on the assumption that the updation has succeeded (the determination result is “YES”). In the case where a problem has been posed in the updation of the software (the determination result is “NO”), callback processing is performed in the step S110. The versions of all the software items are restored to the original versions thereof.

### <Stopped-Service Corresponding Processing>

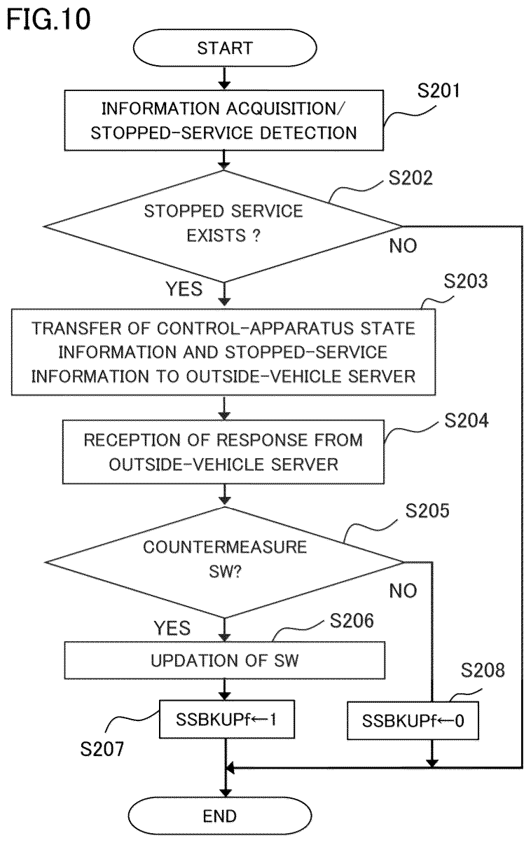

FIG. 10 is a flowchart of stopped-service corresponding processing by the vehicle software management apparatus 100 according to Embodiment 1. Processing contents to be utilized in the stopped-service corresponding processing are written in the storage apparatus 91 of the vehicle software management apparatus 100. The computing processing unit 90 of the vehicle software management apparatus 100 executes the processing contents.

The processing in the flowchart in FIG. 10 is performed every predetermined time (for example, every 10 ms). The processing represented in FIG. 10 may be performed not every predetermined time but every event, for example, each time the vehicle has traveled a predetermined distance or each time the vehicle software management apparatus 100 has received data from the outside-vehicle server 900. In addition, it may be allowed that the flowchart in FIG. 10 and the flowchart in FIG. 9 are executed in conjunction with each other.

After the processing is started, the information acquisition unit 101 acquires information in the step S201. Specifically, the information acquisition unit 101 acquires the control-apparatus state information, the function-version information, and the software-service information. Then, the stopped-service detection unit 102 detects a stopped service and acquires the stopped-service information.

It is determined in the step S202 whether or not there exists a stopped service detected by the stopped-service detection unit 102. In the case where there exists no stopped service (the determination result is “NO”), the processing is ended. In the case where there exists a stopped service (the determination result is “YES”), the step S202 is followed by the step S203.

In the step S203, the communication unit 103 transmits the control-apparatus state information and the stopped-service information to the outside-vehicle server. In the step S204, the communication unit 103 receives a response from the outside-vehicle server.

In the step S205, it is determined whether or not the contents received as a response from the outside-vehicle server are countermeasure software corresponding to the stopped service. In the case where the contents are not countermeasure software (the determination result is “NO”), the stopped-service backup flag SSBKUPf is cleared in the step S208; then, the processing is ended.

In the case where in the step S205, the contents received, as a response, from the outside-vehicle server is countermeasure software corresponding to the stopped service (the determination result is “YES”), the software updating unit 104 instructs the corresponding control apparatus to update the software in the step S206, so that the software updating is performed. After that, in the step S207, the stopped-service backup flag SSBKUPf is set; then, the processing is ended.

### 2. Embodiment 2

### <Configuration of Outside-Vehicle Server>

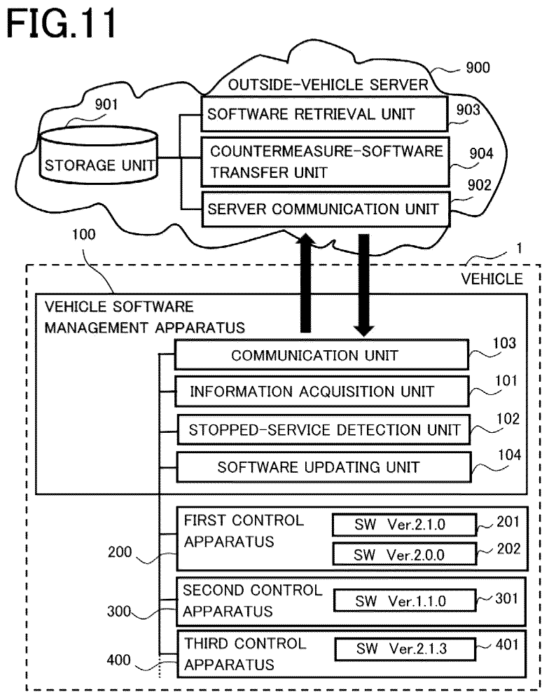

FIG. 11 is a configuration diagram of a vehicle software management system according to Embodiment 2 that includes the vehicle software management apparatus 100 and the outside-vehicle server 900. FIG. 11 is different from FIG. 1 in that the configuration of the outside-vehicle server 900 is described therein. Embodiment 2 is different from Embodiment 1 only in that the details of the outside-vehicle server 900 are specified; the reference numerals in Embodiment 2 are the same as those in Embodiment 1.

The outside-vehicle server 900 has a storage unit 901, a software retrieval unit 903, and a countermeasure-software transfer unit 904, in addition to the server communication unit 902. In the outside-vehicle server 900, the storage unit 901 stores all versions of software items for a vehicle such as the vehicle 1. In addition, the storage unit 901 stores function-version information that indicates the function and the version of software and software-service information that indicates the relationship between a service and software.

Each time the latest version of software is released, the new version of the software is stored in the storage unit 901, and then the provision thereof to respective vehicles is started. The outside-vehicle server 900 responds to a request from the vehicle software management apparatus 100. In response to a request, the outside-vehicle server 900 transfers the latest function version of the software and transmits the latest version of the software. The outside-vehicle server 900 comprehends the respective software-updation situations of the vehicles, and collectively manages the respective states of the software items for the vehicles.

The outside-vehicle server 900 receives the stopped-service information from the vehicle software management apparatus 100. In the case where there exists a stopped service, the software retrieval unit 903 retrieves, from the storage unit 901, the software version with which the normal control apparatus of the vehicle 1 performs the stopped service. In the case where there exists the software version with which the normal control apparatus performs the stopped service, the countermeasure-software transfer unit 904 transfers the function version of the software to the vehicle software management apparatus 100. In this case, server communication unit 902 transmits the function version of the software, as countermeasure software.

### <Communication Processing by Outside-Vehicle Server>

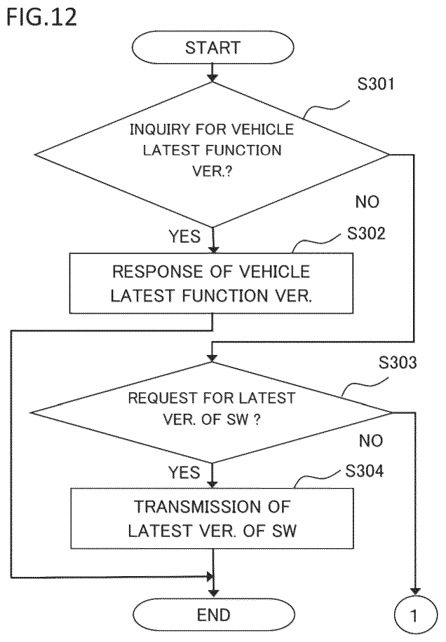

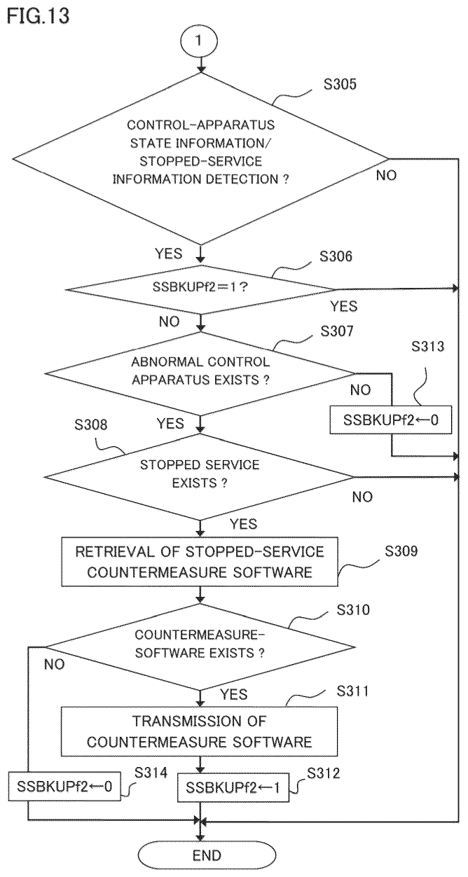

FIG. 12 is a first flowchart of communication processing by the outside-vehicle server 900 according to Embodiment 2. FIG. 13 is a second flowchart of the communication processing. The flowchart in FIG. 13 follows the flowchart in FIG. 12.

The processing in the flowchart in FIG. 12 is performed each time the outside-vehicle server 900 receives data from the vehicle software management apparatus 100. The processing in the flowchart in FIG. 12 may be performed not at each time of reception but every predetermined time (for example, every 10 ms).

In the step S301 after the start of the processing, it is determined whether or not the received data from the vehicle software management apparatus 100 is an inquiry for the latest function version of software for the vehicle. In the case where the received data from the vehicle software management apparatus 100 is an inquiry for the latest function version of software for the vehicle (the determination result is “YES”), the step S301 is followed by the step S302, where the latest function version of software for the vehicle is transmitted; then, the processing is ended.

In the case where in the step S301, the received data is not an inquiry for the latest function version of software (the determination result is “NO”), the step S301 is followed by the step S303. Then, it is determined whether or not the received data is a transmission request for the latest version of software. In the case where the received data is a transmission request for the latest version of software (the determination result is “YES”), the step S303 is followed by the step S304, where the latest function version of software is transmitted; then, the processing is ended.-{ }-

In the case where in the step S303, the received data is not a transmission request for the latest version of software (the determination result is “NO”), the step S303 is followed by the step S305 in FIG. 13. In the step S305, it is determined whether or not the received data items from the vehicle software management apparatus 100 are the control-apparatus state information and the stopped-service information. In the case where the received data items from the vehicle software management apparatus 100 are not the control-apparatus state information and the stopped-service information (the determination result is “NO”), the processing is ended. In the case where the received data items from the vehicle software management apparatus 100 are the control-apparatus state information and the stopped-service (the determination result is “YES”), the step S305 is followed by the step S306.

In the step S306, it is determined whether or not a second stopped-service backup flag SSBKUPf2 has been set. In the case where the second stopped-service backup flag SSBKUPf2 has been set (the determination result is “YES”), the processing is ended. The second stopped-service backup flag SSBKUPf2 is a flag indicating that a stopped service has been detected and then countermeasure software for dealing therewith has been transmitted. In the case where the second stopped-service backup flag SSBKUPf2 has been set, the countermeasure software is not newly transmitted.

In the case where in the step S306, the second stopped-service backup flag SSBKUPf2 has not been set (the determination result is “NO”), the step S306 is followed by the step S307. In the step S307, it is determined whether or not there exists an abnormal control apparatus. In the case where there exists no abnormal control apparatus (the determination result is “NO”), the step S307 is followed by the step S313, where the second stopped-service backup flag SSBKUPf2 is cleared; then, the processing is ended. The reason for that is to provide against the case where an abnormality occurs in the control apparatus.

In the case where in the step S307, there exists an abnormal control apparatus (the determination result is “YES”), the step S307 is followed by the step S308. In the step S308, it is determined whether or not there exists a stopped service. In the case where there exists no stopped service (the determination result is “NO”), the processing is ended. In the case where there exists a stopped service (the determination result is “YES”), the step S308 is followed by the step S309.

In the step S309, a stopped-service countermeasure software is retrieved. That is to say, the software retrieval unit 903 retrieves, from the storage unit 901, the software version with which the normal control apparatus of the vehicle 1 performs the stopped service. In the step S310, it is determined whether or not a stopped-service countermeasure software is found through the retrieval. In the case where there exists no stopped-service countermeasure software (the determination result is “NO”), the second stopped-service backup flag SSBKUPf2 is cleared in the step S314; then, the processing is ended.

In the step S310, in the case where there exists stopped-service countermeasure software (the determination result is “YES”), the countermeasure software is transmitted to the vehicle software management apparatus 100 in the step S311. After that, in the step S312, the second stopped-service backup flag SSBKUPf2 is set; then, the processing is ended.

Such a configuration of the outside-vehicle server 900 makes it possible that in the case where an abnormality occurs in the control apparatus of the vehicle 1 and hence a service through software cannot be continued, the software version with which the normal control apparatus can continue the service is retrieved and transmitted. As a result, the vehicle software management apparatus 100 can instruct the corresponding control apparatus to update the received software; thus, the service can be continued. Accordingly, the vehicle software management system including the vehicle software management apparatus 100 and the outside-vehicle server 900 makes it possible to continue provision of a necessary service; thus, the convenience is enhanced.

### 3. Embodiment 3

### <Abnormal-Control-Apparatus Countermeasure Software>

In each of Embodiments 1 and 2, there has been explained the case where when an abnormality occurs in the control apparatus, the outside-vehicle server 900 retrieves and finds a software version with which the service can be continued without utilizing the abnormal control apparatus and then transmits the software version to the vehicle software management apparatus 100. However, there can be conceived the case where there exists no software version with which the service can be continued without utilizing the abnormal control apparatus. There will be explained the case where in that case, the software version with which the number of software items to be executed by the abnormal control apparatus becomes minimum is retrieved and then transmitted to the vehicle software management apparatus 100.

In some cases, there exists a service, among various kinds of services, that can be continued even when part of sensors, part of actuators, or part of control apparatuses become abnormal. There also exists a case where even when a service is continued while part of functions are degenerated, no large problem is posed. Moreover, there exists a limp-home driving in which even when there exists a problem, it is prioritized to reach home, a repair shop, or a shelter by means of a degenerated driving. Accordingly, there will be explained the case where when a control apparatus becomes abnormal, software is updated to the version thereof with which the number of software items to be executed by the abnormal control apparatus becomes minimum.

The configurations of the vehicle software management apparatus 100 and the outside-vehicle server 900 utilized in the explanation for Embodiment 2 can be applied, as they are, to those according to Embodiment 3. The outside-vehicle server 900 according to Embodiment 3 can be configured only by changing software items for the outside-vehicle server 900; thus, reference numerals the same as those in Embodiments 1 and 2 will be utilized.

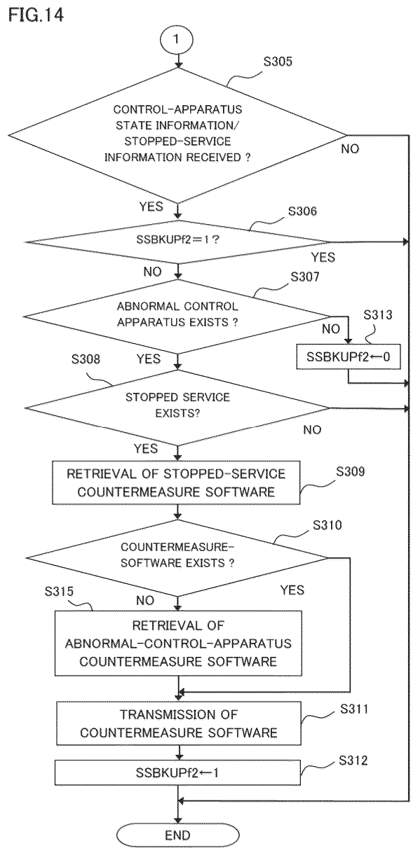

FIG. 14 is a second flowchart of communication processing by the outside-vehicle server 900 according to Embodiment 3. FIG. 12 will be utilized, as it is, as the first flowchart of the communication processing by the outside-vehicle server 900 according to Embodiment 3. FIG. 14 is different from FIG. 13 only in that the step S314 in FIG. 13 is replaced by the step S315 and then the step S315 is followed by the S311 after the processing in the step S315. Hereinafter, only the different parts will be explained.

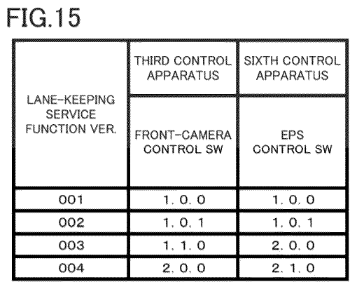

FIG. 15 is a table representing software-service information according to Embodiment 3. FIG. 15 represents collaborative software items related to a lane-keeping service. The lane-keeping service is a service for assisting a driver in such a way that a vehicle travels while keeping the central position of a lane on which the vehicle is traveling. The lane-keeping service can prevent a vehicle from taking an unstable course while traveling and from traveling in a wobbly manner, due to fatigue of a driver, a doze, scattering of attention, or the like.

In each of Embodiments 1 and 2, in the case where an abnormality occurs in the third control apparatus, there is retrieves and found the software version with which a service can continuously be provided without utilizing the third control apparatus. However, with regard to the service in FIG. 15, there exists no software version to be executed without utilizing the third control apparatus.

There will be considered the case where even in that case, provision of optimum software by the outside-vehicle server is not given up and the software version with which the number of software items to be executed by the abnormal control apparatus becomes minimum is retrieved and then transmitted to the vehicle software management apparatus 100.

In the step S310 in the second flowchart of the communication processing by the outside-vehicle server in FIG. 14, it is determined whether or not a stopped-service countermeasure software has been found through the retrieval. In the case where there exists no stopped-service countermeasure software (the determination result is “NO”), the step S310 is followed by the step S315.

In the case where there exists no stopped-service countermeasure software, the software retrieval unit 903 of the outside-vehicle server 900 retrieves an abnormal-control-apparatus countermeasure software in the step S315. The abnormal-control-apparatus countermeasure software is a software version with which the number of software items to be executed by an abnormal control apparatus becomes minimum.

The software retrieval unit 903 retrieves and extracts such software and transfers it to the vehicle software management apparatus 100. Accordingly, software for the corresponding control apparatus is updated, and hence the effect of the abnormal control apparatus can be suppressed to a minimum.

The abnormal control apparatus cannot execute software. However, in the case where the corresponding software is not executed, the number of services to be stopped due to this can be decreased to a minimum. Moreover, even when part of collaborate software items cannot be executed, there exist some services that can be continued by degenerating the functions.

The vehicle software management system including the vehicle software management apparatus 100 and the outside-vehicle server 900 makes it possible to assist traveling of a vehicle, while continuing services by the vehicle control apparatuses and suppressing the degeneration degree of degenerated driving to a minimum. Thus, the vehicle software management system raises the convenience.

Although the present disclosure is described above in terms of various exemplary embodiments and implementations, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the specification of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF REFERENCE NUMERALS

1: vehicle, 100: vehicle software management apparatus, 101: information acquisition unit, 102: stopped-service detection unit, 103: communication unit, 104: software updating unit, 200: first control apparatus, 201, 202, 301, 401: software, 300: second control apparatus, 400: third control apparatus, 900: outside-vehicle server, 901: storage unit, 902: server communication unit, 903: software retrieval unit, 904: countermeasure-software transfer unit

1. A vehicle software management apparatus comprising:
an information acquisitor that acquires
control-apparatus state information that indicates whether two or more control apparatuses provided in a vehicle operate normally or abnormally,
function-version information that indicates a function and a version of software to be executed by each of the control apparatuses, and
software-service information that indicates a relationship between the software and a service to be executed by use of the software;
a stopped-service detector that detects a stopped service that is the service that has been made inexecutable by the control apparatus whose operation is abnormal;
a communicator that transfers, to an outside-vehicle server, the control-apparatus state information acquired by the information acquisitor and stopped-service information from the stopped-service detector; and
a software updater that instructs the control apparatus to update the software,
wherein in the case where the stopped-service detector detects the stopped service, the communicator unit receives, from the outside-vehicle server, a version of the software with which a normal control apparatus executes the stopped service, and
wherein the software updater instructs the control apparatus on updation to the software received from the outside-vehicle server.

2. The vehicle software management apparatus according to claim 1,
wherein in the case where the control apparatus normally operates, the communicator issues a request for a latest version of software to the outside-vehicle server and receives the latest version of software, and
wherein the software updater instructs the control apparatus on updation to the software received from the communicator unit.

3. The vehicle software management apparatus according to claim 1,
wherein in the case where there exists the control apparatus whose operation has become abnormal, the communicator receives, from the outside-vehicle server, a version of the software with which the number of software items to be executed by the abnormal control apparatus becomes minimum, and
wherein the software updater instructs the control apparatus on updation to the software received from the outside-vehicle server.

4. The vehicle software management apparatus according to claim 1,
wherein in the case where when the stopped-service detector detects the stopped service, there exists a version of the software with which the normal control apparatus executes the stopped service, the communicator receives the software from the outside-vehicle server, and in the case where there exists no version of the software with which the normal control apparatus executes the stopped service, the communicator receives, from the outside-vehicle server, a version of the software with which the number of software items to be executed by the abnormal control apparatus becomes minimum, and
wherein the software updater instructs the control apparatus on updation to the software received from the outside-vehicle server.

5. A vehicle software management system comprising:
the outside-vehicle server including
a storage that stores respective functions and versions of a plurality of the software items to be executed by each of the control apparatuses provided in the vehicle and software-service information indicating a relationship between the software and the service to be executed by use of the software,
an outside-vehicle-server communicator that transmits the software in response to a request from the vehicle software management apparatus and receives the control-apparatus state information and the stopped-service information from the vehicle software management apparatus,
a software retriever that retrieves, from the software-service information in the storage, a version of the software with which the normal control apparatus executes a stopped service, in the case where the stopped-service information received by the outside-vehicle-server communicator indicates existence of the stopped service, and
a countermeasure-software transmitter that reads, from the storage, the software whose version has been retrieved by the software retriever and that makes the outside-vehicle-server communicator transmit the software to the vehicle software management apparatus; and
the vehicle software management apparatus according to claim 1.

6. A vehicle software management system comprising:
the outside-vehicle server including
a storage that stores respective functions and versions of a plurality of the software items to be executed by each of the control apparatuses provided in the vehicle and software-service information indicating a relationship between the software and the service to be executed by use of the software,
an outside-vehicle-server communicator that transmits the software in response to a request from the vehicle software management apparatus and receives the control-apparatus state information and the stopped-service information from the vehicle software management apparatus,
a software retriever that retrieves, from the software-service information in the storage, a version of the software with which the number of software items to be executed by the control apparatus whose operation is abnormal becomes minimum, in the case where the control-apparatus state information received by the outside-vehicle-server communicator indicates existence of the control apparatus whose operation is abnormal, and
a countermeasure-software transmitter that reads, from the storage, the software whose version has been retrieved by the software retriever and that makes the outside-vehicle-server communicator transmit the software to the vehicle software management apparatus; and
the vehicle software management apparatus according to claim 3.

7. A vehicle software management system comprising:
the outside-vehicle server including
a storage that stores respective functions and versions of a plurality of the software items to be executed by each of the control apparatuses provided in the vehicle and software-service information indicating a relationship between the software and the service to be executed by use of the software,
an outside-vehicle-server communicator that transmits the software in response to a request from the vehicle software management apparatus and receives the control-apparatus state information and the stopped-service information from the vehicle software management apparatus,
a software retriever that retrieves, from the software-service information in the storage, a version of the software with which the normal control apparatus executes a stopped service, in the case where the stopped-service information received by the outside-vehicle-server communicator indicates existence of the stopped service, and that retrieves, from the software-service information in the storage, a version of the software with which the number of software items to be executed by the control apparatus whose operation is abnormal becomes minimum, in the case where there does not exist the software with which the normal control apparatus executes the stopped service, and
a countermeasure-software transmitter that reads, from the storage, the software whose version has been retrieved by the software retriever and that makes the outside-vehicle-server communicator transmit the software to the vehicle software management apparatus; and
the vehicle software management apparatus according to claim 4.

8. The vehicle software management apparatus according to claim 2,
wherein in the case where there exists the control apparatus whose operation has become abnormal, the communicator receives, from the outside-vehicle server, a version of the software with which the number of software items to be executed by the abnormal control apparatus becomes minimum, and
wherein the software updater instructs the control apparatus on updation to the software received from the outside-vehicle server.

9. The vehicle software management apparatus according to claim 2,
wherein in the case where when the stopped-service detector-detects the stopped service, there exists a version of the software with which the normal control apparatus executes the stopped service, the communicator receives the software from the outside-vehicle server, and in the case where there exists no version of the software with which the normal control apparatus executes the stopped service, the communicator receives, from the outside-vehicle server, a version of the software with which the number of software items to be executed by the abnormal control apparatus becomes minimum, and
wherein the software updater instructs the control apparatus on updation to the software received from the outside-vehicle server.

10. A vehicle software management system comprising:
the outside-vehicle server including
a storage that stores respective functions and versions of a plurality of the software items to be executed by each of the control apparatuses provided in the vehicle and software-service information indicating a relationship between the software and the service to be executed by use of the software,
an outside-vehicle-server communicator that transmits the software in response to a request from the vehicle software management apparatus and receives the control-apparatus state information and the stopped-service information from the vehicle software management apparatus,
a software retriever that retrieves, from the software-service information in the storage, a version of the software with which the normal control apparatus executes a stopped service, in the case where the stopped-service information received by the outside-vehicle-server communicator indicates existence of the stopped service, and
a countermeasure-software transmitter that reads, from the storage, the software whose version has been retrieved by the software retriever and that makes the outside-vehicle-server communicator transmit the software to the vehicle software management apparatus; and
the vehicle software management apparatus according to claim 2.

11. A vehicle software management system comprising:
the outside-vehicle server including
a storage that stores respective functions and versions of a plurality of the software items to be executed by each of the control apparatuses provided in the vehicle and software-service information indicating a relationship between the software and the service to be executed by use of the software,
an outside-vehicle-server communicator that transmits the software in response to a request from the vehicle software management apparatus and receives the control-apparatus state information and the stopped-service information from the vehicle software management apparatus,
a software retriever that retrieves, from the software-service information in the storage, a version of the software with which the number of software items to be executed by the control apparatus whose operation is abnormal becomes minimum, in the case where the control-apparatus state information received by the outside-vehicle-server communicator indicates existence of the control apparatus whose operation is abnormal, and
a countermeasure-software transmitter that reads, from the storage, the software whose version has been retrieved by the software retriever and that makes the outside-vehicle-server communicator transmit the software to the vehicle software management apparatus; and
the vehicle software management apparatus according to claim 8.

12. A vehicle software management system comprising:
the outside-vehicle server including
a storage that stores respective functions and versions of a plurality of the software items to be executed by each of the control apparatuses provided in the vehicle and software-service information indicating a relationship between the software and the service to be executed by use of the software,
an outside-vehicle-server communicator that transmits the software in response to a request from the vehicle software management apparatus and receives the control-apparatus state information and the stopped-service information from the vehicle software management apparatus,
a software retriever that retrieves, from the software-service information in the storage, a version of the software with which the normal control apparatus executes a stopped service, in the case where the stopped-service information received by the outside-vehicle-server communicator indicates existence of the stopped service, and that retrieves, from the software-service information in the storage, a version of the software with which the number of software items to be executed by the control apparatus whose operation is abnormal becomes minimum, in the case where there does not exist the software with which the normal control apparatus executes the stopped service, and
a countermeasure-software transmitter that reads, from the storage, the software whose version has been retrieved by the software retriever and that makes the outside-vehicle-server communicator transmit the software to the vehicle software management apparatus; and
the vehicle software management apparatus according to claim 9.
